(19) United States
(12) Patent Application Publication
(10) Pub. No.: US 2026/0065769 A1
(43) Pub. Date: Mar. 5, 2026

(54) System

(71) Applicant: Softbank Group Corp, Tokyo (JP)

(72) Inventor: Izumi Asahara, Tokyo (JP)

(21) Appl. No.: 19/314,329

(22) Filed: Aug. 29, 2025

(30) Foreign Application Priority Data
Sep. 4, 2024 (JP) 2024-152612

(51) Int. Cl. G08B 21/24; G06V 10/82; G06V 40/10; G08B 21/18

(52) U.S. Cl. CPC G08B 21/24; G06V 10/82; G06V 40/10; G08B 21/182

(57) ABSTRACT

The system uses a processor to receive streaming video from cameras at set intervals, preprocess the data, and analyze it with an AI model to detect dirt or pests. Detection results, including confidence scores, timestamps, and camera locations, are stored in a database. When the confidence score exceeds a threshold, the system identifies areas needing attention and sends a notification to the user's terminal. The notification is displayed in real time as a push or in-app message. The system can also receive user questions, analyze them using natural language processing, generate answers, and display them on the user interface.

### CROSS-REFERENCE TO RELATED APPLICATION

This application is based on and claims priority under 35 USC 119 from Japanese Patent Application No. 2024-152612 filed on Sep. 4, 2024, which is incorporated by reference herein in its entirety.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional household cleaning management relies heavily on the user's observation and memory to identify areas requiring cleaning or special attention. This approach is inefficient and often results in overlooked dirt or pest issues, delayed cleaning actions, and unsanitary living environments. Additionally, users may lack timely and specific guidance on cleaning methods and required tools, further reducing the effectiveness of their efforts. There is a need for a system that can continuously monitor household cleanliness, promptly detect problems such as dirt and pests, notify users in real time, and provide detailed cleaning instructions when needed.

### SUMMARY

The present invention provides a system comprising a processor that periodically receives video data in a streaming format from one or more camera devices installed in the household. The processor performs preprocessing of the received video data and utilizes an artificial intelligence model to detect dirt and pests. Detection results, including confidence scores, timestamps, and camera location information, are recorded in a database. When the confidence score exceeds a predetermined threshold, the processor extracts the relevant area, generates an appropriate notification message, and sends it to a user terminal, where it is displayed in real time as a push notification or in-app message. Further, the system receives and analyzes user questions regarding cleaning using a natural language processing model, generates a specific answer such as cleaning procedures or recommended tools, and displays the answer via the user interface, thereby supporting efficient and effective household cleaning.

“Video data” means image or video information captured by camera devices and transmitted to the system in a streaming or frame-based format.

“Camera device” means a device installed in the household which is capable of capturing and transmitting image or video data to the system.

“Processor” means a hardware or software computational unit, or a combination thereof, for executing the functions of the system as described in the claims.

“Preprocessing” means a set of operations performed on received video data to prepare it for further analysis, including noise reduction, resolution conversion, and color space transformation.

“Artificial intelligence model” means a computer-implemented model, such as a neural network or other machine learning algorithm, trained to analyze video data and detect objects, such as dirt or pests.

“Dirt” means any form of visible contamination, stain, or residue detected within the field of view of the camera, which may require cleaning.

“Pest” means any unwanted animal or insect, such as bugs or rodents, detected within the field of view of the camera.

“Confidence score” means a numerical value output by the artificial intelligence model indicating the likelihood or probability that dirt or pests has been correctly detected.

“Timestamp” means temporal information representing the date and/or time at which the video data was captured or processed.

“Camera location information” means metadata indicating the physical placement or area in the household where the camera device is installed.

“Database” means a structured data storage system used to record and manage detection results, including images, confidence scores, timestamps, and camera location information.

“Notification message” means electronic information generated by the processor to alert or inform the user about detected dirt or pests or recommended cleaning actions.

“User terminal” means an electronic device, such as a smartphone, tablet, or computer, which receives and displays notification messages and instructions to the user.

“User interface” means the graphical or interactive element on the user terminal that allows the user to view notifications, input questions, and receive answers.

“Natural language processing model” means a computer-implemented system or algorithm capable of analyzing and interpreting user questions stated in natural human language.

“Specific answer” means a response generated by the system, typically including detailed cleaning methods, procedures, or recommendations for tools appropriate to the user's question.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or”is employed to link three or more items in the present specification.

### First Exemplary Embodiment

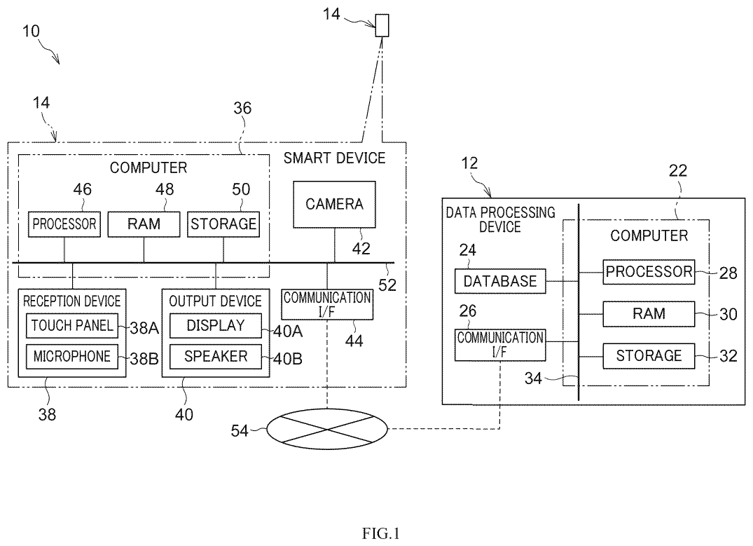

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

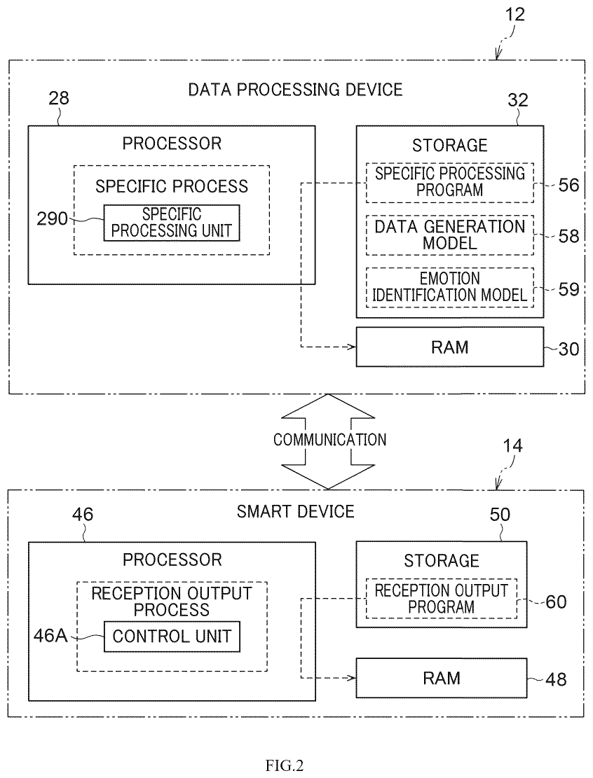

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

In living spaces, maintaining cleanliness and promptly identifying dirt or pests are significant challenges, as the detection of such issues often requires considerable time and effort. Moreover, users frequently lack accurate information on cleaning techniques and appropriate tools, which hinders effective maintenance of hygiene in the environment. There is a need for an automated system that can not only detect dirt or pests at an early stage with high reliability but also promptly inform users and offer appropriate cleaning solutions through an interactive interface.

The specific processing by the specific processing unit 290 of the data processing device 12 in Example 1 is realized by the following means.

The present invention provides a server comprising a processor configured to periodically acquire image information from image acquisition devices, preprocess such information, detect abnormal conditions using a convolutional artificial intelligence inference model, record detection results with associated confidence information, time information, and spatial information to a storage device, generate and transmit notification messages to a user terminal when a predefined threshold is exceeded, and process user inquiries through a generative natural language inference model with prompt sentences, thereby providing specific responses to user questions about cleaning methods and tools. This enables automated and reliable early detection of abnormal hygiene conditions, real-time notification to users, and delivery of actionable cleaning guidance through an advanced interactive system.

The term “processor” refers to a central processing unit or computational device capable of executing instructions to perform data processing and control operations within the system.

The term “image acquisition device” refers to any apparatus or sensor, such as a digital camera or imaging module, used to capture image information from a specific location in an environment.

The term “image information” refers to visual data obtained by the image acquisition device, including but not limited to still images and video frames.

The term “sequential signal transmission” refers to the process of transmitting digital information from one device to another in a continuous or periodic manner.

The term “information preprocessing” refers to a set of data processing operations performed on raw image information, including noise reduction, resolution conversion, and color space conversion, to enhance the quality and utility of the data for subsequent analysis. The term “convolutional artificial intelligence inference model” refers to a type of machine learning model, typically a convolutional neural network (CNN), used to perform automated image analysis and detect patterns or abnormalities in image information.

The term “object abnormality information” refers to information indicating the detection of unusual or unwanted objects, such as dirt, stains, or pests, within the acquired image information.

The term “confidence information” refers to a numerical or categorical value indicating the probability or reliability that the detected object abnormality in an image is accurate.

The term “time information” refers to data indicating the chronological moment an image was acquired or an object abnormality was detected.

The term “installation location information” refers to data specifying the spatial origin or position within an environment where an image was taken or an event was detected. The term “information storage device” refers to a hardware or software-based repository, such as a database or memory unit, used to record and retain detection results and related metadata.

The term “work instruction information” refers to guidance or recommendations relating to cleaning or maintenance actions required based on the detection of object abnormalities.

The term “alert information” refers to information generated to notify users of detected conditions that require immediate attention or intervention.

The term “notification message” refers to a communication generated by the processor to inform the user about detected object abnormalities and recommended actions through the user information terminal.

The term “user information terminal” refers to any user-operated computing device, including but not limited to smartphones, tablets, or computers, that receives and displays notifications and communication from the system.

The term “screen output module” refers to a component or software installed on the user information terminal that facilitates real-time display of notifications and system messages.

The term “inquiry information” refers to a question or request for information submitted by the user, often concerning cleaning procedures or tool usage.

The term “generative natural language processing inference model” refers to a machine learning model capable of producing natural language responses to user inquiries, based on prompt sentences and underlying language data.

The term “prompt sentence” refers to a structured or guiding phrase included in a user inquiry, designed to elicit a specific and contextually relevant response from the generative artificial intelligence model.

The term “response” refers to the natural language answer generated by the generative artificial intelligence inference model in reply to a user's inquiry.

A preferred embodiment of the present invention is described as follows.

The server includes a processor and an information storage device. The server is communicatively connected to one or more image acquisition devices installed throughout an indoor environment, such as a kitchen, living room, or entrance area. These image acquisition devices may be general-purpose digital cameras or web cameras configured to periodically transmit image information (still images or video frames) to the server via a sequential signal transmission protocol, such as RTSP or HTTP stream.

The server utilizes software including, but not limited to, an image processing library such as OpenCV, a database management system such as PostgreSQL, a machine learning framework such as TensorFlow or PyTorch, and a generative natural language processing model accessible via a public or private API.

Upon receiving an image, the server preprocesses the raw image information using OpenCV. The preprocessing may include pixel noise reduction through Gaussian filtering, transformation to a predetermined image resolution (such as HD format), and conversion of the color space from RGB to grayscale to improve computational efficiency and detection accuracy.

The server analyzes the preprocessed image information by inputting it into a convolutional artificial intelligence inference model, such as a CUDA-accelerated convolutional neural network deployed with TensorFlow or PyTorch. The model identifies object abnormality information, such as the presence of dirt, stains, or pests, and assigns a confidence information value to each detected abnormality.

The server stores the detected abnormality information, confidence values, time information, and installation location information in a database for later retrieval and analysis.

If the confidence information for any detected abnormality exceeds a threshold value (for example, 90%), the server generates a notification message describing the recommended cleaning or maintenance action. The notification message is transmitted as a push notification or in-app message to the user information terminal, such as a smartphone or tablet, utilizing middleware such as Firebase Cloud Messaging or a similar service.

The user information terminal displays the notification message in real time through a screen output module implemented via a dedicated application or web interface. The user can interact with the application and input inquiry information regarding appropriate cleaning methods or suitable tools for the detected abnormality.

Once the terminal receives an inquiry, it sends the inquiry information to the server. The server interprets the inquiry by utilizing a generative AI model such as a large language model (LLM), which may be accessed via a public API or operated as an internal on-premises system. The server constructs and appends a prompt sentence designed to elicit a targeted and contextually appropriate response regarding cleaning methods or required tools.

For example, a typical prompt sentence used by the server may be: “Please explain in easy steps how to clean a kitchen drain. The answer should be suitable for a beginner, include the required tools, and be under 120 words.”

Alternatively, for a user input in another language:

“Kicchin no haisuikou no souji houhou wo shoshinsha muke ni wakariyasuku suteppu goto ni setsumei shite kudasai. Hitsuyou na dougu mo awasete, 120 moji inai ni kanketsu ni matomete kudasai.”

The generative AI model then provides a natural language response, which the server sends to the user's terminal, where it is displayed in the application's chatbot interface. The user can then refer to this response and take the appropriate maintenance action.

With this embodiment, the system enables automated and reliable cleanliness management in living spaces by combining a series of advanced image processing, artificial intelligence detection, and interactive generative AI model communication techniques, integrated across server and client hardware and software platforms.

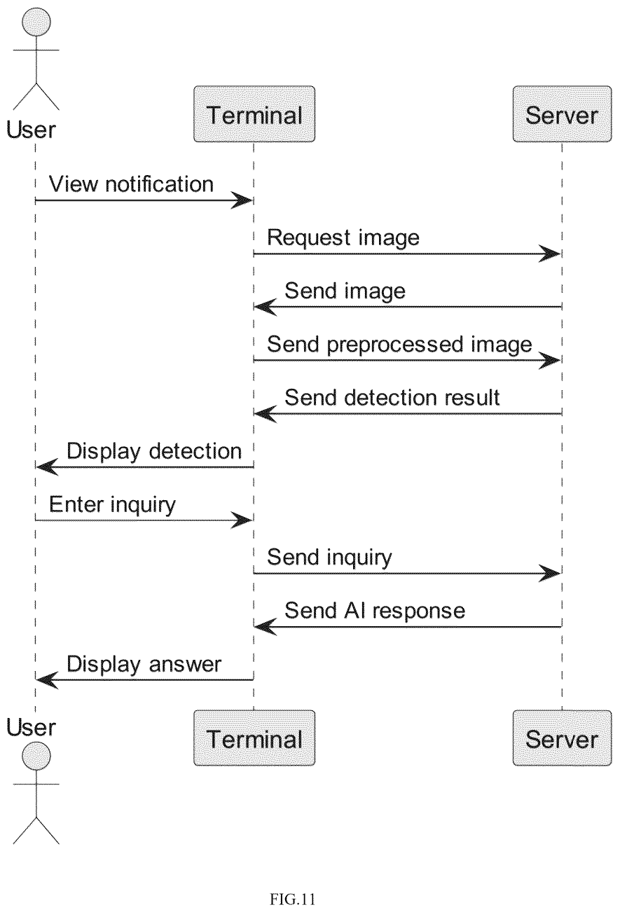

The following describes the processing flow using FIG. 11.

### Step 1:

The server receives image information from the image acquisition device installed in a specific area, such as the kitchen or living room.
Input: Raw image or video stream from the image acquisition device.
Output: Raw image information stored temporarily on the server.
The server converts the incoming video stream into individual image frames and prepares them for further processing.

### Step 2:

The server preprocesses the received image information using image processing software such as OpenCV.
Input: Raw image information.
Output: Preprocessed image information (noise removed, resolution adjusted, color space converted).
The server applies a Gaussian filter to reduce noise, resizes the image to a predetermined resolution (for example, 1280×720 pixels), and converts the image from RGB to grayscale format.

### Step 3:

The server analyzes the preprocessed image using a convolutional artificial intelligence inference model implemented in TensorFlow or PyTorch.
Input: Preprocessed image information.
Output: Detection results including abnormality label, confidence value, and detected location.
The server performs inference with the AI model, detects an object abnormality such as dirt or a pest, calculates a confidence score, and identifies the relevant position within the image.

### Step 4:

The server records the detection result, along with the confidence value, timestamp, and installation location, into the information storage device (such as a PostgreSQL database).
Input: Detection results, confidence value, timestamp, location information.
Output: Stored detection record in the database.
The server inserts the relevant data into a structured database for later review and processing.

### Step 5:

The server evaluates whether any detected abnormality has a confidence value exceeding a predetermined threshold (for example, 90%). If so, the server generates a notification message recommending appropriate cleaning or maintenance actions.
Input: Stored detection record from the database.
Output: Generated notification message text.
The server creates a message such as “The kitchen drain is dirty. It's time to clean.”

### Step 6:

The server transmits the generated notification message to the user information terminal, such as a smartphone or tablet, via a push notification or app-specific communication channel.
Input: Notification message text.
Output: Notification message received by the terminal.
The server uses a messaging service to send the notification to the user's mobile application.

### Step 7:

The terminal displays the received notification message in real time using its user interface application.
Input: Notification message from the server.
Output: Notification display on the screen for the user.
The terminal triggers a visual alert or push notification within the application to inform the user.

### Step 8:

The user reviews the message and, as needed, enters an inquiry about cleaning methods or tools using the terminal's chatbot interface.
Input: Notification message and user input (inquiry).
Output: Inquiry information generated and sent to the server.
The user types a question such as, “How do I clean the drain?”using the app.

### Step 9:

The terminal sends the user's inquiry to the server for processing.
Input: Inquiry information from the user.
Output: Transmitted inquiry to the server.
The terminal encodes the text and triggers an API request to the server.

### Step 10:

The server constructs a prompt sentence based on the user's inquiry and the detected abnormality, then formulates a request to the generative AI model (large language model), either through a public or private API.
Input: User's inquiry and detection context.
Output: Prompt sentence and request for an AI-generated response.
The server creates a prompt such as:
“Please explain in easy steps how to clean a kitchen drain. The answer should be suitable for a beginner, include the required tools, and be under 120 words.”

### Step 11:

The server receives the AI-generated response from the generative model and transmits this response to the user's terminal.
Input: AI-generated response.
Output: Response delivered to the terminal.
The server receives a response like, “To clean the drain: 1. Remove the drain cover. 2. Brush off dirt. 3. Rinse with disinfectant,”and sends it to the app.

### Step 12:

The terminal displays the AI-generated response in its chatbot interface for the user's reference.
Input: Response from the server.
Output: Displayed answer on the user's terminal.
The terminal presents the recommended cleaning steps, enabling the user to take immediate action.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional home monitoring and cleaning management systems typically focus on detecting dirt and pests using camera devices, but lack advanced features such as the detection of suspicious behavior for improved security. Furthermore, current systems do not offer instant and personalized advice or instructions to users through natural language interaction, and they are unable to adapt their communications based on the user's psychological or emotional state. Therefore, there is a need for a system that can integrate real-time detection of environmental status and security threats, provide immediate and easy-to-understand notifications, interact with users naturally using generative AI models, and deliver personalized responses that consider the user's emotional condition.

The specific processing by the specific processing unit 290 of the data processing device 12 in Application Example 1 is realized by the following means.

The present invention provides a server comprising a processor configured to acquire streaming image data from imaging devices, process and analyze the images using machine learning algorithms to detect contamination, pests, and suspicious behaviors, store structured detection information into a storage medium, generate and transmit notification information to an information terminal when specific conditions are detected, present notifications visually in real time on the terminal, receive and analyze user inquiries using language processing technology and generative AI models, and determine the user's psychological state from audio or video input to personalize the content or format of notifications and responses. This enables integrated cleaning and security management with adaptive, real-time user communication and support that takes into account the user's emotional status.

The term “processor” refers to an electronic circuit or device capable of interpreting and executing instructions to perform computational or control tasks within a system.

The term “imaging device” refers to a hardware apparatus, such as a camera or sensor, that captures visual information in the form of image data or video streams.

The term “image data” refers to digital information representing visual content obtained from an imaging device, which may include single frames or continuous video streams.

The term “preprocessing” refers to a set of computational operations applied to raw image data, such as noise reduction, resolution conversion, and color space conversion, to enhance or standardize the data for further analysis.

The term “machine learning algorithm” refers to a computational method, including neural networks, that enables a system to analyze data, recognize patterns, and make predictions or decisions without being explicitly programmed for each task.

The term “structured information” refers to data that is organized in a defined format, including attributes such as detection results, confidence scores, timestamps, and device location information, to enable systematic storage and retrieval.

The term “storage medium” refers to a physical or virtual device or component, such as a memory unit or database, for saving and retaining digital data within a system.

The term “notification information” refers to generated data or messages that inform or alert a user about detected conditions, tasks, or important events, such as work instructions, warnings, or system updates.

The term “information terminal” refers to a user-operated electronic device, including but not limited to a mobile terminal, tablet, or personal computer, capable of receiving, displaying, and transmitting digital information.

The term “language processing technology” refers to computational methods for analyzing and understanding natural language inputs, including intent detection and semantic interpretation, typically employed in user interaction systems.

The term “generative language processing model” refers to a machine learning model, such as a generative AI model, capable of producing contextually appropriate and human-like natural language responses based on user inputs or prompts.

The term “psychological state” refers to an estimation of a user's mental or emotional condition, such as fatigue, interest, or tension, as determined by analyzing behavioral, auditory, or visual data.

The term “audio input or video input” refers to data streams or files containing sound or visual recordings obtained from user-operated devices, which are analyzed to infer various user states or triggers for system actions.

The term “display area” refers to a portion of a screen or interface on an information terminal designated to visually present data, messages, or interactive content to the user.

A system includes a server comprising a processor and storage media, a plurality of imaging devices such as network cameras, and user information terminals such as mobile terminals or computers. The imaging devices are installed in various locations within an environment, such as a home or office, and are configured to capture image data in a streaming format via a communication network.

The server is implemented using general-purpose computing hardware such as a multicore central processing unit (CPU) or a graphics processing unit (GPU), running on an appropriate operating system (for example, a Linux or Windows platform). The server uses pre-existing software libraries such as OpenCV for image signal preprocessing, TensorFlow or PyTorch for machine learning inference, and a relational or non-relational database management system such as PostgreSQL or MongoDB to structure and store detection results. The imaging devices regularly transmit image data using the Real Time Streaming Protocol (RTSP) or a similar network protocol. The server receives and preprocesses this image data, performing noise reduction with OpenCV's Gaussian filter, resolution transformation, and color space conversion. The preprocessed image data is analyzed on the server using a pre-trained convolutional neural network (CNN) or other machine learning models, which have been trained to recognize contamination, the presence of pests, and suspicious activities (such as unexpected human movement during nighttime hours).

The server attaches a confidence score, a timestamp, and a location identifier to each detection result and stores the structured information into a database. The server automatically and periodically queries the database. If a determination is made that a result's confidence score exceeds a preset threshold, the server generates an appropriate notification message. For security events, the notification may indicate the detection of a suspicious behavior at a certain time or place. For cleaning events, it might specify a location requiring attention. The server then transmits this message to the user's information terminal via a service such as Firebase Cloud Messaging (FCM) or another push notification system.

The user terminal, which can be a smartphone or tablet running iOS or Android, receives the push notification and immediately displays it to the user through the user interface, accompanied by an appropriate alert sound or visual indicator.

The system also includes a natural language interface on the user's information terminal, where the user can input queries related to cleaning methods, safety instructions, or general advice by typing or voice input. The user's prompt sentence is transmitted to the server, where it is processed using a generative language model, such as GPT-3 or BERT. The server interprets the query, determines an appropriate response, and returns a detailed answer to the user terminal for display through the chatbot interface.

Furthermore, the system is capable of determining the user's psychological state by analyzing audio input (for example, the tone of voice) or video input (for example, the facial expression), using an emotion recognition model implemented on the server. The server personalizes future notification messages and generated responses according to the detected psychological state, for example, by providing extra encouragement if fatigue is detected or by being more reassuring if stress is inferred.

To illustrate, if the server detects dirt in the kitchen sink, it can generate and send a notification: “Kitchen drain is dirty. Time to clean.” If the server registers suspicious activity at night, a notification such as “Suspicious movement detected in the hallway at 2:00 a.m. Please check your home.” is sent. The user can interact with the chatbot by entering prompts such as:
How do I clean the kitchen drain?
What should I do if a suspicious person is detected in my home?

The server uses its generative language model to respond with answers such as:
“To clean the kitchen drain: 1. Remove the drain cover. 2. Scrub with a brush. 3. Rinse using disinfectant.”
“If a suspicious person is detected, move to a safe area and contact emergency services as soon as possible.”

If the server detects that the user appears fatigued on the basis of a voice sample, it may adjust the message to: “You seem tired today. Would you like to postpone cleaning until tomorrow?”

By integrating standard hardware (such as network cameras and mobile terminals) and widely-used software libraries (such as OpenCV, TensorFlow, PyTorch, PostgreSQL, MongoDB, and generative AI models), the invention can be realized as a flexible, adaptive, and user-oriented environmental monitoring and support system. The system can be readily implemented and customized for various scales and contexts, including but not limited to private homes, commercial buildings, or shared community spaces.

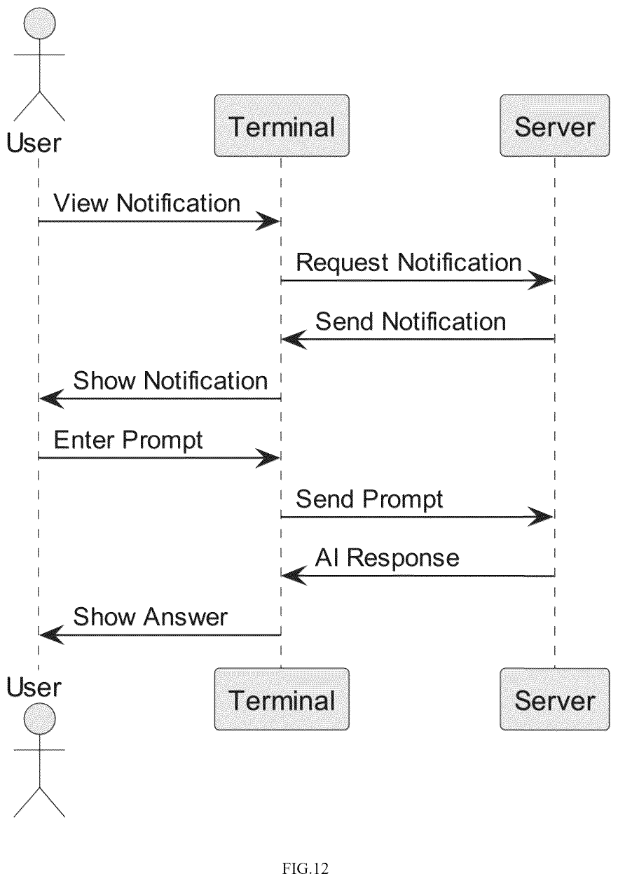

The following describes the processing flow using FIG. 12.

### Step 1:

Server initiates a network connection to each imaging device via protocols such as RTSP.
Input: IP addresses and stream credentials of the imaging devices.
Server receives real-time video stream data packets from each imaging device and temporarily stores them as image frames in a dedicated memory buffer.
Output: Raw image frames buffered on the server.

### Step 2:

Server preprocesses each received image frame using an image processing library (such as OpenCV).
Input: Raw image frames from Step 1.
Server performs operations including Gaussian blur for noise reduction, resolution downscaling, and color conversion to grayscale on every frame.
Output: Preprocessed image frames optimized for analysis.

### Step 3:

Server analyzes preprocessed frames by passing them through a deployed machine learning model (such as a TensorFlow or PyTorch CNN).
Input: Preprocessed image frames from Step 2.
Server's model predicts the presence and location of dirt, pests, or suspicious human activity, returning a list of detection types, bounding boxes, and confidence scores.
Output: Detection results with associated metadata (detection type, confidence score, bounding box, timestamp).

### Step 4:

Server inserts detection results into a structured database (such as PostgreSQL or MongoDB) for later access and monitoring.
Input: Detection results and metadata from Step 3.
Server tags each record with a timestamp, camera location, and the corresponding confidence score.
Output: Structured detection records stored in the database.

### Step 5:

Server periodically queries the database to search for any records where the confidence score exceeds a preset threshold.
Input: Detection records from the database.
Server filters and extracts relevant events that require user attention and calls a notification generation module to create a notification message (for example, “Dirt detected in kitchen sink”or “Suspicious activity in the hallway”).
Output: Generated notification messages waiting to be sent.

### Step 6:

Server sends the notification messages to the user's information terminal using a communication service such as Firebase Cloud Messaging.
Input: Generated notification messages from Step 5 and user device registration information.
Server formats the notification into a message payload and pushes it to the registered user's mobile terminal.
Output: Delivered notification message to the user terminal.

### Step 7:

Terminal receives the push notification and triggers an alert mechanism (sound, vibration, or popup) to display the message on the user interface.
Input: Notification payload from the server.
Terminal presents the notification visually and stores it in the device's notification history.
Output: Notification displayed to the user.

### Step 8:

User reads the notification and may input a question or request for further advice through the terminal's interface (either by typing or by voice input).
Input: Notification information and user prompt sentence.
User provides a prompt, such as “How do I clean the kitchen drain?” or “What should I do if a suspicious person is detected?”
Output: User question submitted to the terminal.

### Step 9:

Terminal transmits the user's prompt sentence to the server using a secure API call.
Input: User's prompt from Step 8.
Terminal packages the prompt in a request and sends it to the server for processing.
Output: User prompt received by the server.

### Step 10:

Server processes the user's prompt using a generative AI model (such as GPT-3 or BERT).
Input: User's prompt sentence from Step 9.
Server analyzes the intent and generates a natural language response, such as step-by-step cleaning instructions or safety advice, possibly referencing emotion adaptation if prior emotional state is known.
Output: Generated Response Message.

### Step 11:

Server sends the generated response message to the terminal for display in the chatbot or conversation interface.
Input: Response message from Step 10 and target terminal identification.
Server delivers the message in a conversational message format.
Output: Response message sent to terminal.

### Step 12:

Terminal displays the server's response in the chatbot interface for the user to read and act upon.
Input: Response message from the server.
Terminal structures the message in the UI, highlights any stepwise procedures or safety advice, and allows further user interaction or feedback.
Output: Chatbot answer displayed to the user.

### Step 13:

User may optionally provide audio or video input through the terminal for emotion analysis.
Input: Audio or video data input through the terminal.
User speaks or records a message, which is sent as data to the server for psychological state assessment.
Output: Audio/video data uploaded to server.

### Step 14:

Server analyzes uploaded audio or video for emotional cues using an emotion recognition algorithm.
Input: Audio or video data from Step 13.
Server processes the input and estimates the user's psychological state, updating the user profile or session context accordingly.
Output: Detected psychological state stored or flagged for use in future communications.

### Step 15:

Server incorporates detected psychological state into future notification and chatbot response messages for adaptive communication.
Input: Updated psychological state from Step 14 and new detection or inquiry events.
Server personalizes the content and tone of upcoming notifications (for example, providing encouragement if fatigue is detected or reassurance if anxiety is present).
Output: Emotion-adapted notifications or chatbot responses for improved user support.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional home cleaning systems have limited automation and do not sufficiently reduce the user's burden. These systems generally fail to account for the emotional state of the user and tend to offer only a single mode of notification, which may result in increased user stress and a suboptimal user experience. Moreover, existing technologies do not provide timely, context-sensitive, and personalized guidance that adapts to both the home environment and the emotional condition of the user.

The specific processing by the specific processing unit 290 of the data processing device 12 in Example 2 is realized by the following means.

The present invention provides a server comprising a processor configured to receive and preprocess image data from a camera device, analyze the image data using a generative artificial intelligence model to detect cleaning targets, store analysis results with associated metadata, automatically generate and transmit context-aware notification messages to an information processing terminal based on those results, receive and analyze user queries with a natural language processing model, analyze the user's emotional state from audio or image data, and dynamically adjust the notification content according to the user's emotional state. This enables a home cleaning support system that offers highly automated, personalized, and user condition-aware support, thereby improving cleaning efficiency and enhancing the comfort and satisfaction of the user.

The term “image data” refers to digital information representing visual content captured by an image acquisition device, such as a camera, in a stream or sequence of frames. The term “image acquisition device” refers to a hardware apparatus capable of capturing and transmitting visual data from an environment, typically in real time, to a processor.

The term “processor” refers to one or more computing units or circuits capable of executing programmed instructions to perform data processing tasks as defined by the system.

The term “preprocessing” refers to a set of operations applied to raw input data, which may include noise removal, resolution conversion, and color space conversion, to prepare the data for subsequent analysis.

The term “noise removal” refers to the process of eliminating unwanted random variations or disturbances in image data to enhance its quality.

The term “resolution conversion” refers to the modification of the spatial size or pixel count of image data to achieve a desired output dimension.

The term “color space conversion” refers to the transformation of image data from one color representation model to another, such as from RGB to grayscale.

The term “generative artificial intelligence model” refers to a computer-based analytical model, such as a neural network, capable of generating predictive or descriptive output based on input data, including the detection of target objects in image data.

The term “object” refers to any discernible target in image data, such as dirt, pests, or other relevant features for cleaning purposes.

The term “confidence indicator” refers to a numerical value input or output by a system reflecting the likelihood or reliability of a detection or classification event produced by an artificial intelligence model.

The term “storage medium” refers to any physical or virtual medium capable of recording and retaining digital data, such as databases, memory, or mass storage devices.

The term “time information” refers to data indicating the specific time at which an event, such as the acquisition or processing of image data, occurs.

The term “device installation location information” refers to metadata specifying where an image acquisition device is physically installed within an environment.

The term “notification message” refers to a machine-generated communication containing information or instructions intended for presentation to a user via a terminal.

The term “information processing terminal” refers to a user-operated electronic device, such as a smartphone, tablet, or computer, that can display notification messages and facilitate user interaction with the system.

The term “visualize” refers to the process of presenting information in a visible or perceptible form to a user, such as through a display screen.

The term “push notification” refers to an alert or message transmitted from a server and displayed on an information processing terminal, often in real time.

The term “query” refers to any question, command, or input submitted by a user to the system seeking information or guidance.

The term “natural language processing model” refers to a computer-implemented analytical module capable of interpreting, processing, and generating responses to human language input.

The term “instruction message” refers to content generated by the system, based on user input analysis, conveying step-by-step or procedural information to the user.

The term “voice information” refers to digital data representing the user's spoken input captured via microphone or similar device.

The term “emotional state” refers to the psychological condition or affective status of a user, such as fatigue or stress, determinable from input data.

The term “notification content adjustment” refers to the modification of a generated message, including its phrasing or tone, in response to the determined emotional state of the user.

Embodiment for Implementing the Invention

The present invention can be implemented as an automated home cleaning support system comprising a server, one or more information processing terminals, and a plurality of image acquisition devices such as cameras installed in various locations in a living environment.

The server may include a computing processor (such as an x86-based server, GPU-accelerated server, or cloud-based server) equipped with software modules built using programming languages such as Python. The server is configured to receive image data streams from each image acquisition device at predetermined intervals. Each image acquisition device is configured to capture real-time video or still images of the surrounding environment and transmit them using network protocols such as RTSP or HTTP, with images encoded in standard formats like H.264.

The server receives these image streams and applies a preprocessing sequence. The preprocessing utilizes libraries such as OpenCV for noise removal (for example, by applying Gaussian filtering), resolution conversion (e.g., downsampling from 1080p to 720p), and color space conversion (e.g., RGB to grayscale). The preprocessed image data is then analyzed by a generative artificial intelligence model. The generative AI model may be implemented as a convolutional neural network (CNN) or transformer neural network, constructed and executed in a deep learning framework such as TensorFlow or other similar platforms.

The server uses the generative AI model to detect objects, including dirt and pests, in the preprocessed image frames, and calculates a confidence indicator representing the probability of correct detection. The server stores the analysis results including the detection labels, confidence indicator, time information, and device installation location information in a storage medium such as a relational database, for example, MySQL.

When the confidence indicator in the stored results exceeds a predetermined threshold, the server extracts the relevant location and generates a notification message. Notification message generation may utilize a template system, or for highly contextual or empathetic notifications, the server may construct a prompt sentence and query a generative artificial intelligence model (such as a large language model). For instance, a typical prompt sentence used by the server could be:

“Notify the current situation: The camera has detected dirt in the kitchen drain. However, the user is feeling tired. Please generate a notification message that includes a gentle suggestion.”

The server then transmits the generated notification message to the user's information processing terminal, which may be a smartphone, tablet, or personal computer. The notification is delivered as a push notification or in-app message using a messaging service such as Firebase Cloud Messaging.

The terminal visualizes the notification message to the user using the device's display system in real time. The user, upon receiving the notification, may interact with the system by entering queries regarding cleaning methods, recommended tools, or other related advice. The user may input text directly or use the device's microphone for voice input.

The terminal transmits the user query to the server. The server uses a natural language processing model, such as a model based on BERT or a generative language model, which may be implemented using the Transformers library, to analyze the query and to generate a specific instruction message, such as step-by-step cleaning procedures. This instruction message is transmitted back to the terminal and displayed for the user.

Furthermore, if the user's voice information or video information is captured and transmitted to the server, the server applies a speech-to-text API (such as a generic cloud-based speech recognition service) and an emotion analysis API (such as a general-purpose emotion recognition service) to determine the emotional state of the user, such as fatigue or stress. Based on the determined emotional state, the server dynamically adjusts the content or tone of the notification messages, providing customized and empathetic guidance. For example, if the user is determined to be tired, the notification may be modified to say, “You seem tired today. Would you like to postpone cleaning the drain?”Through this configuration, the system provides a high level of automation and personalization in supporting cleaning activities, responds in real time to both environmental and user condition inputs, and delivers user-friendly, emotionally adaptive notifications and guidance to enhance overall user experience and cleaning efficiency.

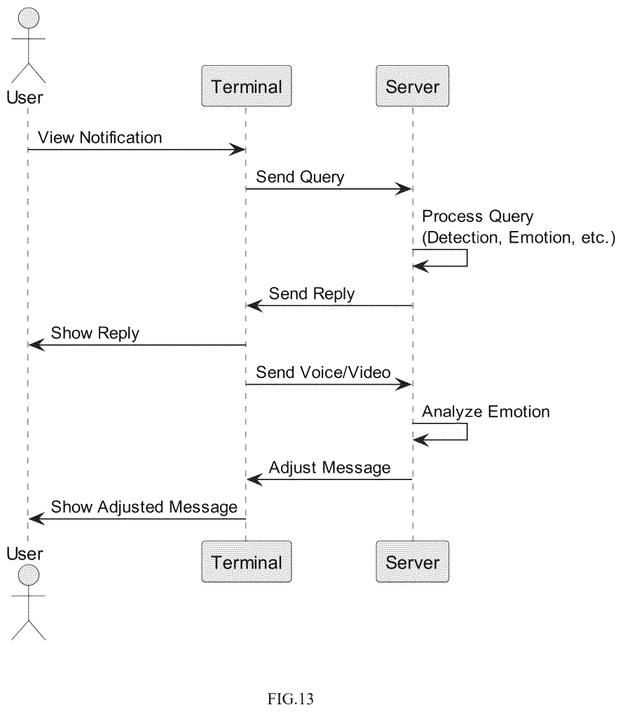

The following describes the processing flow using FIG. 13.

### Step 1:

The server receives real-time image data streams from multiple image acquisition devices installed in various locations in the home environment. The input is the H.264 encoded video stream transmitted by the cameras, and the output is the raw frame data received by the server. The server monitors each connection and manages failover if a camera stream is interrupted.

### Step 2:

The server preprocesses the received raw frame data. The input for this step is the raw image frame data from Step 1. The server applies noise removal using Gaussian blur, resizes the images from 1080p to 720p resolution, and converts the color space from RGB to grayscale using the OpenCV library. The output is a set of preprocessed image frames ready for analysis.

### Step 3:

The server analyzes the preprocessed image frames using a generative AI model, such as a convolutional neural network implemented in TensorFlow. The input is the batch of preprocessed frames from Step 2. The server uses the model to perform object detection for dirt and pests, generating for each frame one or more class labels and an associated confidence indicator. The output is a list of detection results for each frame, including timestamps, labels, and confidence indicators.

### Step 4:

The server stores the analysis results in a database. The input is the detection results, confidence indicators, timestamps, and device installation location information from Step 3. The server writes these entries to a structured storage medium such as a MySQL database. The output is persistent records of analysis results, retrievable for later use.

### Step 5:

The server evaluates the latest records in the database to determine whether the confidence indicator for a given target exceeds a predetermined threshold. The input is the most recent analysis results retrieved from the database. If a threshold is exceeded, the server extracts the target position and timing and generates a notification message. The output is a notification message tailored to the detected object and its location.

### Step 6:

The server transmits the generated notification message to the terminal. The input is the notification message from Step 5. The server uses a push notification service to send the message to the registered information processing terminals, such as smartphones or tablets. The output is the real-time delivery of the notification message to the terminal.

### Step 7:

The terminal displays the notification message to the user via the device's screen. The input is the notification message delivered to the terminal. The output is the visual display of the message in the terminal's notification center or app interface. The terminal also enables user interaction, such as acknowledging the message or tapping for more details.

### Step 8:

The user inputs a query related to cleaning actions, tools, or procedures via the terminal's user interface. The input is the user's typed or spoken question, such as “How do I clean the kitchen drain?”The output is the query data entered and confirmed by the user.

### Step 9:

The terminal transmits the user's query to the server using a secure network protocol. The input is the user query data from Step 8, and the output is the query received by the server backend for analysis.

### Step 10:

The server processes the received query with a natural language processing model, such as a BERT-based or generative AI model implemented with the Transformers library. The input is the user's text query and associated context (for example, previous detections or location data). The server analyzes the query, constructs a prompt sentence if necessary, and generates an instruction message containing appropriate steps or advice. The output is a detailed instruction message tailored to the user's query.

### Step 11:

The server sends the instruction message generated in Step 10 back to the terminal. The input is the instruction message, and the output is the delivery and display of these instructions on the terminal for the user.

### Step 12:

The terminal may capture the user's voice or video data, such as during verbal query input, and transmit this data to the server for emotion analysis. The input for this step is audio or video data from the user; the output is the successful uploading of this data to the server.

### Step 13:

The server analyzes the voice or video data using an emotion analysis API and may also use a speech recognition API to convert speech to text. The input is the audio or video data acquired in Step 12. The server processes the data to determine the user's emotional state, such as stress or fatigue. The output is an emotion classification result associated with the user session.

### Step 14:

The server adjusts or personalizes subsequent notification messages according to the determined emotional state of the user. The input is the emotion classification result and the template or context of the notification message. The server alters the phrasing or timing of the next notification message to be more empathetic or user-friendly, if required—for example, by including a suggestion to postpone cleaning if the user is tired. The output is an emotion-adaptive, customized notification message, which is then delivered following Steps 6 and 7.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

In conventional environments such as retail stores, it is difficult for staff to provide personalized responses in accordance with the nuanced emotional state of each customer, which often results in uniform quality of service and lower customer satisfaction. Furthermore, there are no systems capable of analyzing real-time image or audio data to recognize customers'emotions and to dynamically generate and deliver context-appropriate notification messages to staff. Additionally, when users have questions regarding the system's recognition or analysis, it is challenging to provide immediate, contextually accurate explanations. These issues hinder the advancement of customer experience and the real-time adaptation of staff behavior based on situational needs.

The specific processing by the specific processing unit 290 of the data processing device 12 in Application Example 2 is realized by the following means.

The present invention provides a server comprising a processor configured to receive image information in a streaming format from an imaging device, preprocess and analyze the image information for objects or individual emotions using a recognition machine learning model, store the analysis results with confidence, time, and location information, generate and transmit notification messages based on the analyzed results, display the notifications, receive and analyze user inquiries, and generate responses using a natural language generation model via a user interaction interface. This enables real-time recognition of the emotional state or other relevant conditions of individuals in an environment and provides dynamically generated, contextually personalized notifications and explanations to staff, leading to improved customization of user service and greater overall customer satisfaction.

The term “image information” refers to data captured in the form of visual representations, including streaming or still images, obtained from an imaging device such as a camera.

The term “imaging device” refers to an apparatus capable of capturing visual data, for example, a digital camera or sensor-equipped terminal, and providing such data to the processor.

The term “streaming manner” refers to the continuous transmission and processing of data in real time as it is captured, rather than in discrete batches.

The term “processor” refers to a hardware or virtual computing unit capable of executing programmed instructions to perform various data processing operations.

The term “preprocessing” refers to the set of operations performed on raw data in order to enhance its quality and suitability for further analysis, such as noise reduction, resizing, or color adjustment.

The term “recognition machine learning model” refers to an algorithm or set of algorithms trained to identify patterns, objects, or emotional states from image or audio data. The term “analysis results” refers to the outputs generated from processing input data, including identified objects, classified emotional states, and corresponding confidence scores.

The term “confidence information” refers to quantitative data representing the degree of certainty or likelihood assigned to a specific analytical result by the recognition machine learning model.

The term “time information” refers to data indicating when a particular event or piece of information was captured or processed, typically represented as a timestamp.

The term “device location information” refers to data representing the spatial position or area from which the information was captured, such as coordinates or zone identifiers.

The term “management information storage device” refers to a hardware or software-based system used for securely storing, managing, and retrieving data generated by the processor.

The term “notification message” refers to any information output intended to alert, inform, or advise a user or system component based on a specific analysis or detection event.

The term “information processing terminal” refers to a user-accessible device that can receive, display, and process digital information, such as a portable terminal or smart glass device.

The term “user interaction interface” refers to the medium or mechanism through which users exchange information or perform interactive operations with the system, such as displays, touch panels, or voice input modules.

The term “inquiry information” refers to a question or request for information submitted by a user to the system through the user interaction interface.

The term “natural language generation model” refers to an artificial intelligence-based algorithm trained to produce human-readable textual responses based on input queries or prompts.

The term “response information” refers to the answer or information generated by the natural language generation model in reply to a user inquiry.

The term “trained deep learning model” refers to a multi-layer artificial neural network that has been previously trained on large datasets to perform complex tasks such as image recognition or emotion classification.

The term “generative artificial intelligence model” refers to a machine learning model capable of creating new content, such as text or notifications, dynamically adapted to specific input or contextual information.

One embodiment for implementing the invention is described below. The system includes a server (processor), at least one terminal (such as a smart glasses device), an imaging device (camera), and user interaction interfaces. The system utilizes combinations of hardware and software resources including general computing equipment, image sensors, wireless communication modules, and software components such as OpenCV, a recognition machine learning model (e.g., DeepFace), natural language generation models (e.g., generative artificial intelligence models), and a database management system.

The terminal, which may be a wearable information processing device like smart glasses, is equipped with an integrated imaging device and display interface. The user, such as store staff, wears the terminal while interacting in the field environment. The terminal continually acquires image information in a streaming manner through its camera and transmits this data to the server wirelessly, for example using Wi-Fi or Bluetooth communication modules.

The server receives image information and executes a sequence of data processing operations. First, the server uses image processing software such as OpenCV to perform preprocessing, including noise reduction, image scaling, and color adjustments. Next, the server applies a recognition machine learning model, such as DeepFace or another trained deep learning model, to detect objects or individual faces and to classify the emotional state of detected individuals. The server then generates analysis results, which include information such as emotional state, timestamp, the confidence score, and device location, and stores them in a database management system for management and later reference.

Based on these analysis results, the server operates a notification generation function to formulate appropriate notification messages. The server may utilize a generative artificial intelligence model to dynamically create tailor-made notification messages reflecting the analyzed emotional state and context. The notification message is sent to the terminal for display to the user via the user interaction interface.

The user receives the real-time notification message through the terminal's display interface (e.g., the smart glasses display), and can use this information to adapt their actions or responses accordingly. If the user has questions about a displayed message or the analysis performed by the system, the user can submit an inquiry through the same user interaction interface using voice or text input.

The terminal then forwards the inquiry to the server. The server applies a natural language generation model (e.g., a generative AI model trained for question answering) to analyze the inquiry and generate an explanatory response, which is displayed back to the user through the user interaction interface. This enables interactive and context-sensitive explanations, further improving user understanding and service quality.

As a concrete example, consider a use case where a staff member wearing smart glasses approaches a customer. The terminal's camera captures image information which is transmitted to the server. The server preprocesses the image using OpenCV, and then analyzes facial features with DeepFace, determining that the customer is likely “angry” with a high confidence score, and records this result in the database with timestamp and location. The server then generates a notification message such as “This customer seems frustrated. Please speak gently and ask if you can help.” using a generative AI model, and transmits this to the staff member's smart glasses for real-time display. If the staff member asks “Why does the system think the customer is angry?”, the server analyzes the inquiry and returns a response such as “The system detected a frown and a sharp voice tone which are typical indicators of anger.”

Example prompt sentence for the generative AI model:
Prompt: Customer detected as angry near the register. Generate a short advice message for staff.
Output: This customer seems frustrated. Please speak gently and ask if you can help.
By applying the aforementioned hardware and software configurations and operational flow, the invention enables personalized, real-time service and adaptable responses in settings where emotional recognition and context-sensitive notification are important.

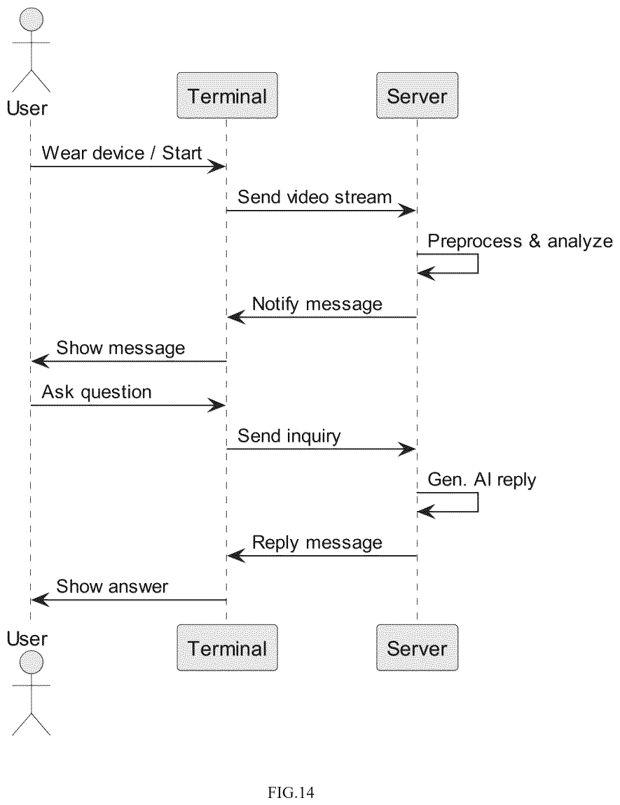

The following describes the processing flow using FIG. 14.

### Step 1:

The terminal activates the imaging device when the user powers on or wears the smart glasses. The terminal captures live image information (video stream) of the surrounding environment, focusing on individuals in the field of view. Input: Real-world scene in front of the user. Output: Raw video stream data transmitted in real time to the server via wireless communication.

### Step 2:

The server receives the raw video stream data from the terminal. The server performs preprocessing on the input video frames using image processing software such as OpenCV, including noise reduction, resizing to a standard resolution, and adjusting color parameters. Input: Raw video data from the terminal. Processing: Image enhancement and normalization. Output: Cleaned and resized video frames suitable for analysis.

### Step 3:

The server analyzes the preprocessed video frames using a recognition machine learning model, such as a trained deep learning model for face and emotion recognition (e.g., DeepFace). The server detects and isolates facial regions in the frames, then classifies the emotional state (for example, happy, angry, neutral) for each detected individual. Input: Preprocessed video frames. Processing: Face detection and emotion classification. Output: For each face, a record including identified emotion, confidence score, and position within the frame.

### Step 4:

The server stores analysis results in a management information storage device (database). The server adds metadata such as timestamp and device location to each record before saving. Input: Emotion recognition record, confidence score, frame position. Processing: Attach time and location metadata, and store in database management system. Output: Structured database entries linking emotional state data with time, place, and confidence.

### Step 5:

The server evaluates the analysis results and decides whether to generate a notification message for the user. If a notable emotional state is detected (such as anger), the server creates a prompt sentence describing the context and uses a generative AI model to generate a personalized notification message. Input: Emotion analysis result and relevant context. Processing: Text generation by generative artificial intelligence model based on prompt. Output: Advice notification message tailored to the specific detected emotion and context.

### Step 6:

The server transmits the generated notification message to the terminal. The terminal receives the message and displays it on the smart glasses'display interface for the user. Input: Notification message from the server. Processing: Display rendering by terminal. Output: Real-time visual notification shown in user's field of view.

### Step 7:

The user observes the notification message on the smart glasses and adapts their response accordingly. The user may approach the detected individual and interact with them in a manner suited to the identified emotional state. Input: Displayed advice message. Processing: Human behavioral adaptation. Output: Personalized customer service or assistance.

### Step 8:

If the user wants further explanation about the notification, the user submits an inquiry through the terminal's input interface (e.g., by voice or touch). The terminal receives the inquiry and transmits it to the server. The server processes the inquiry by generating a prompt sentence and feeding it to a natural language generation model. The server returns the model's response—an explanatory message—to the terminal for display. Input: User inquiry (question about the situation). Processing: Language understanding and response generation by generative AI model. Output: Explanatory answer displayed on the terminal for the user.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

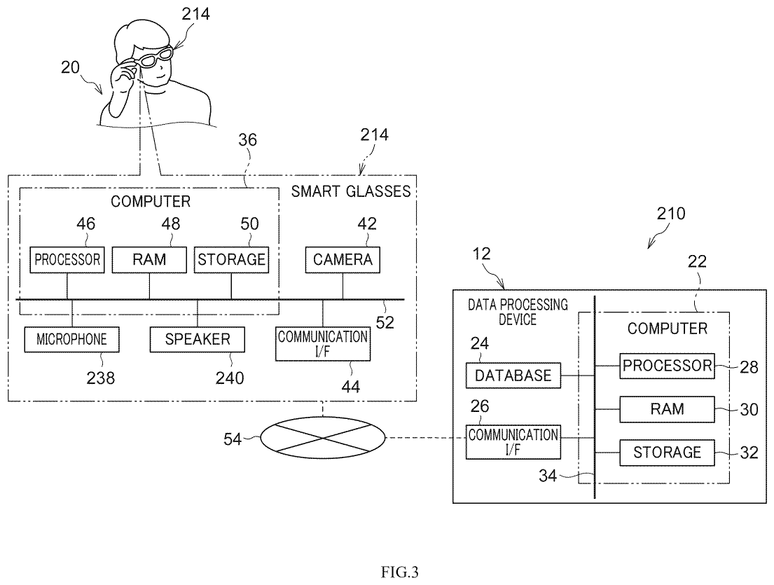

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

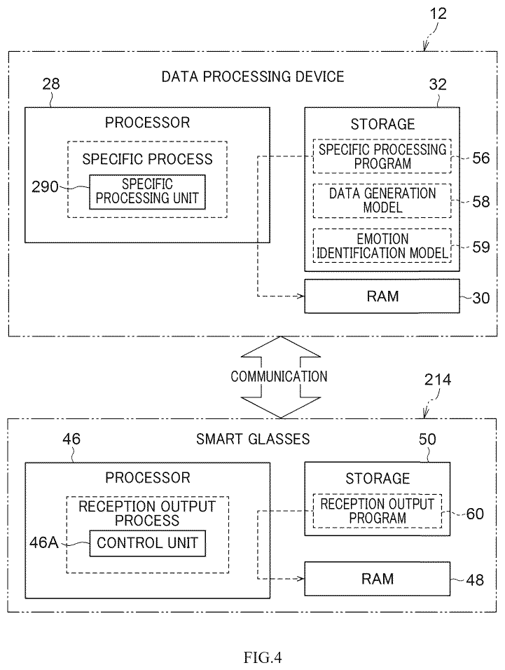

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

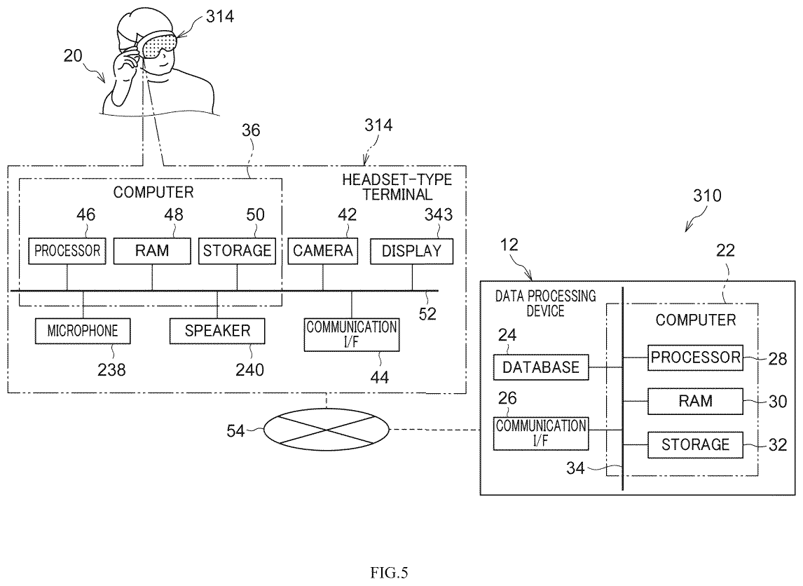

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

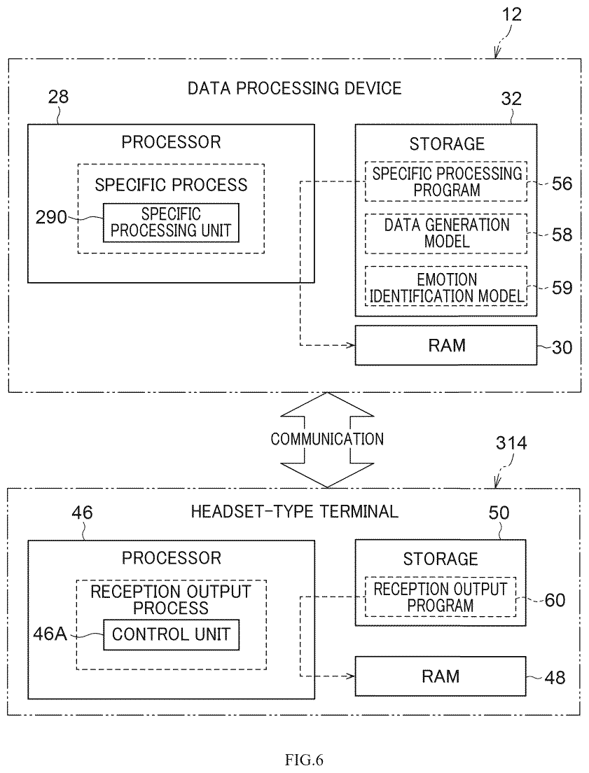

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

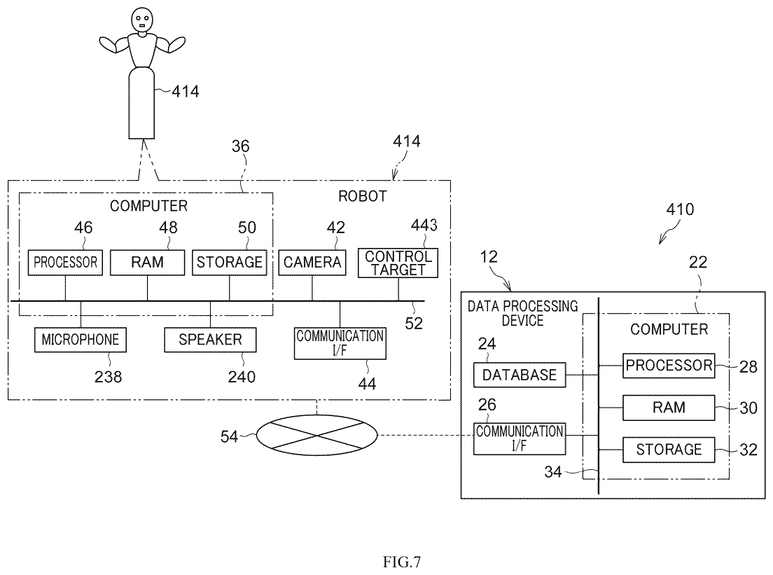

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

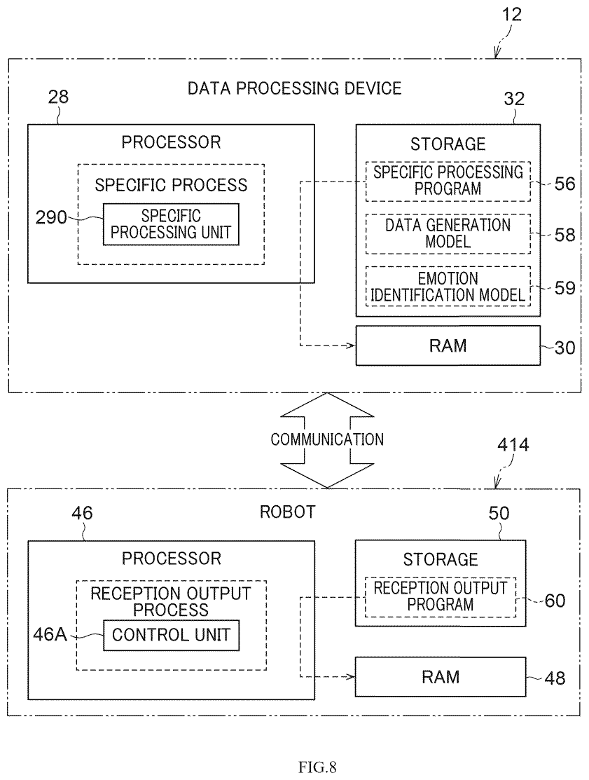

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

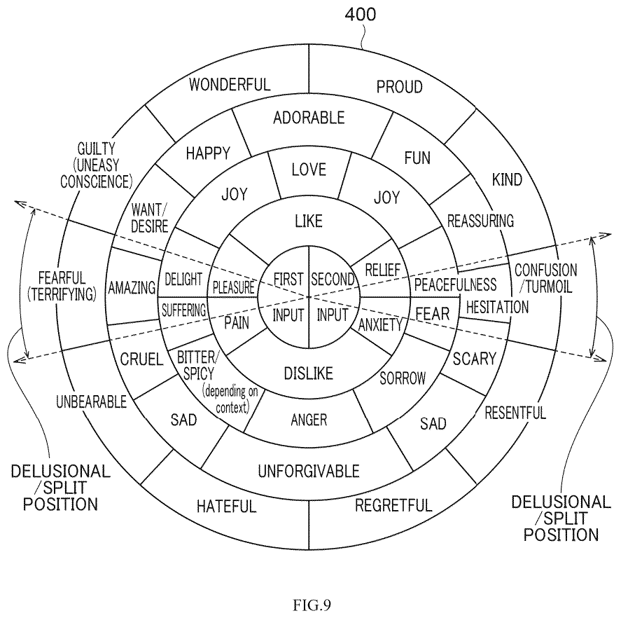

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety.

Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more”and “want to know more”is experienced.

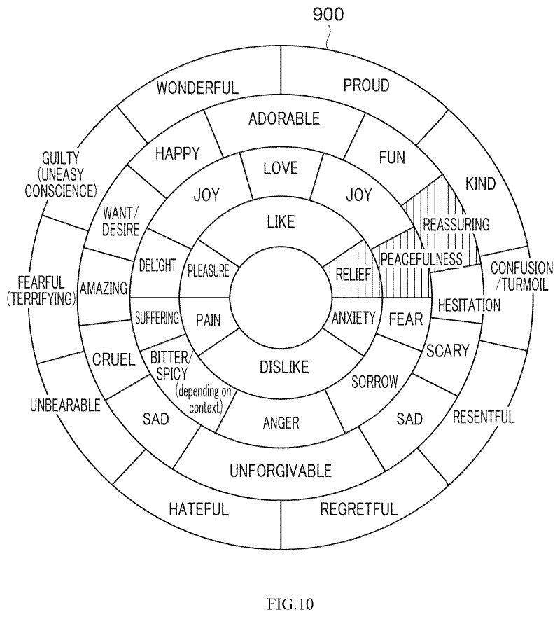

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured”are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
periodically acquire image information from an image acquisition device via sequential signal transmission,
perform information preprocessing on the received image information, and detect object abnormality information using a convolutional artificial intelligence inference model,
store the detected object abnormality information, corresponding confidence information, time information, and installation location information in an information storage device,
extract, when the confidence information exceeds a predetermined threshold, work instruction information or alert information as a target for output, and generate an appropriate notification message,
transmit the generated notification message to a user information terminal,
display the notification message in real time on a screen output module executed on the user information processing device,
receive inquiry information from a user, interpret the inquiry using a generative natural language processing inference model with a prompt sentence, automatically generate a response, and display the response through the screen output module.

### (Supplementary 2)

The system according to supplementary 1,
wherein the processor is configured to
perform preprocessing of the image information including pixel noise reduction, image resolution conversion, and color space conversion.

### (Supplementary 3)

The system according to supplementary 1,
wherein the processor is configured to
add a predetermined prompt sentence to an inquiry from the user, transmit the combined inquiry and prompt to an external or internal generative artificial intelligence model, and output the received answer to the user information terminal.

### Application Example 1

### (Supplementary 1)

A system comprising a processor,
wherein the processor is configured to
acquire image data in a streaming format from an imaging device through a network on a periodic basis,
perform preprocessing on the acquired image data to apply signal noise reduction, resolution conversion, and color space conversion,
analyze the preprocessed image data using a machine learning algorithm, including neural networks, to detect contamination, pests, and suspicious behaviors,
store the detection result, confidence score, imaging time, and imaging location in a storage medium as structured information,
extract information whose confidence score exceeds a predetermined threshold from among the detection results, and generate notification information indicating work instructions or alerts,
transmit the generated notification information to an information terminal through a communication network,
control a display area of the information terminal to visually present the notification information immediately,
receive inquiry content from a user, determine user intent by language processing technology, automatically generate response information using a generative language processing model, and output the response information to the display area,
determine a psychological state of the user from audio input or video input, and adjust the content or expression format of the notification information or response information according to the psychological state.

### (Supplementary 2)

The system according to supplementary 1,
wherein the processor is configured to input a prompt sentence received from a user into a generative language processing model and generate and output a response message that includes a procedure description, safety measure, or operation recommendation.

### (Supplementary 3)

The system according to supplementary 1,
wherein the processor is configured to, in a case where the user's psychological state is determined to be a specific state including fatigue, interest, or tension, add motivational, considerate, or empathetic expressions to the notification information or response information.

### Example 2

### (Supplementary 1)

A system comprising a processor,
wherein the processor is configured to
receive image data periodically from an image acquisition device as a stream,
perform preprocessing on the received image data, the preprocessing including noise removal, resolution conversion, and color space conversion,
analyze the preprocessed image data using a generative artificial intelligence model to detect an object and calculate a confidence indicator,
store analysis results and the confidence indicator in a storage medium together with time information and device installation location information,
extract a target location and generate a notification message when the confidence indicator in the stored analysis results exceeds a predetermined threshold,
transmit the generated notification message to an information processing terminal,
visualize the notification message as a push notification or an information display on the information processing terminal,
receive a query from a user, analyze the query using a natural language processing model, generate an instruction message, and display it on the information processing terminal,
analyze voice information or image information of the user, determine the emotional state, and adjust the notification content based on the generated emotional state.

### (Supplementary 2)

The system according to supplementary 1,
wherein the processor is configured to
generate a prompt sentence as an input for the generative artificial intelligence model using analysis target information, user state information, and location information as input elements, and generate a notification output sentence by the notification message generation process.

### (Supplementary 3)

The system according to supplementary 1,
wherein the processor is configured to
change the expression of the notification message to a friendly or concessive content and present it to the user when the emotional state of the user is determined to be fatigue or stress by the notification adjustment process.

### Application Example 2

### (Supplementary 1)

A system comprising a processor,
wherein the processor is configured to
receive, at predetermined intervals, image information from an imaging device in a streaming manner;
perform preprocessing on the received image information and analyze objects or individual emotional states using a recognition machine learning model;
store analysis results with confidence information, adding time information and device location information into a management information storage device;
generate an appropriate notification message based on the analyzed emotional state or detection contents;
transmit the generated notification message to an information processing terminal;
display the notification message and receive inquiries from a user via a user interaction interface; and
analyze inquiry information, generate response information using a natural language generation model, and output the response information via the user interaction interface.

### (Supplementary 2)

The system according to supplementary 1,
wherein the processor is configured to analyze facial features within the image information and classify an individual's emotional state by using a trained deep learning model.

### (Supplementary 3)

The system according to supplementary 1,
wherein the processor is configured to utilize a generative artificial intelligence model to dynamically adjust the expression of the notification message based on the emotional state or contextual information.

What is claimed is:

1. A system comprising a processor that is configured to:
receive, at predetermined intervals, video data in a streaming format from one or more camera devices;
perform preprocessing on the received video data, inputs the preprocessed video data to an artificial intelligence model, and detects at least dirt or pests in the video data,
record detection results together with confidence scores, timestamps, and camera location information to a database;
extract locations requiring cleaning or user attention when the confidence score exceeds a predetermined threshold and generates an appropriate notification message,
send the generated notification message to a user terminal;
display, in real time, the notification message as a push notification or an in-app message on a user interface of the user terminal;
and receive a question from the user, analyzes the received question using a natural language processing model, generates a specific answer to the question, and displays the answer on the user interface of the user terminal.

2. The system according to claim 1,
wherein the processor generates the notification message based on the location data and the type of detected dirt or pest.

3. The system according to claim 1,
wherein the processor generates, in response to the received question, a cleaning procedure or tools recommendation as the specific answer.
